(19) United States
(12) Patent Application Publication
(10) Pub. No.: US 2026/0243358 A1
(43) Pub. Date: Aug. 20, 2026

(54) FLOW PATH SWITCHING VALVE

(71) Applicant: MARELLI CORPORATION, Saitama (JP)

(72) Inventors: Masahiro KATOU, Saitama (JP); Tomohiro MARUYAMA, Saitama (JP); Kouji HIRONO, Saitama (JP); Tooru KAWAMATA, Saitama (JP); Norimitsu MATSUDAIRA, Saitama (JP)

(21) Appl. No.: 19/471,542

(22) PCT Filed: Apr. 3, 2024
(86) PCT No.: PCT/JP2024/013811

§ 371 Date: Oct. 1, 2025

(30) Foreign Application Priority Data
Apr. 6, 2023 (JP) 2023-062269
Mar. 27, 2024 (JP) 2024-051495

(51) Int. Cl. F16K 11/085

(52) U.S. Cl. CPC F16K 11/0856

(57) ABSTRACT

A housing having a cylindrical inner wall part, the hous-ing being such that a plurality of ports are unevenly distributed and opened in a circumferential-direction portion; and a plurality of valve bodies that are accommodated inside the housing so as to be capable of rotating about a center axis the valve bodies having seal surfaces in sliding contact with the inner wall, and switching the communication state of the plurality of ports. The inner wall part has: a first inner wall part in which the plurality of ports are provided; and a second inner wall part in which the ports are not provided, the second inner wall part facing the first inner wall part with the center axis therebetween.

### TECHNICAL FIELD

The present invention relates to a flow path switching valve that switches a flow path of a fluid.

### CONVENTIONAL TECHNOLOGY

WO2022/218406A1 discloses a control valve (flow path switching valve) including a cylindrical main body part (housing) having a valve cavity, a valve core disposed within the valve cavity and driven to rotate, and a seal member formed in an arc along the radial direction of the valve core and disposed between the valve core and the valve cavity. In this control valve, the seal member has two through holes along the circumferential direction, and is provided on a part of the circumference so as to seal only the periphery of the through holes.

### SUMMARY OF THE INVENTION

However, in the control valve described in WO 2022/218406A1, the seal member is formed separately from the main body part, and is radially compressed between the valve core and the valve cavity to ensure sealing around the through hole. Therefore, there is a concern that the seal member may deteriorate due to sliding of the valve core.

An object of the present invention is to ensure sealing performance while reducing sliding resistance.

According to one aspect of the present invention,
a flow path switching valve includes:
a housing having a cylindrical inner wall part and in which a plurality of ports
are unevenly distributed and open in a part of the circumferential direction; and
a plurality of valve bodies that are stowed inside the housing so as to be rotatable about a central axis and have sealing surfaces that come into sliding contact with the inner wall part and switch communication states of the plurality of ports; wherein
the inner wall part includes a first inner wall part in which the plurality of ports are provided, and a second inner wall part that faces the first inner wall part across the central axis and in which ports are not provided, and
the second inner wall part has an enlarged diameter part having a portion with a larger radius from the central axis than the first inner wall part, and the radius from the central axis changes in the axial direction or radial direction.

According to this configuration, the inner wall part of the housing includes a first inner wall part in which the plurality of ports are provided, and a second inner wall part that faces the first inner wall part across the central axis and in which ports are not provided. The second inner wall part has an enlarged diameter part having a portion with a larger radius from the central axis than the first inner wall part, and the radius from the central axis changes in the axial direction or radial direction. Therefore, by the sealing surfaces of the valve body slidingly contacting the first inner wall part, the communication state of the plurality of ports can be switched while ensuring sealing performance, and by providing the enlarged diameter part, the sliding resistance between the valve body and the second inner wall part is reduced. Therefore, it is possible to ensure sealing performance while reducing sliding resistance.

### BRIEF DESCRIPTION OF THE DRAWINGS

FIG. 1 is an external perspective view of a flow path switching valve according to an embodiment of the present invention;

FIG. 2 is an exploded perspective view of FIG. 1;

FIG. 3 is a perspective view of a valve body and a rotating shaft;

FIG. 4 is a perspective view of a cover part;

FIG. 5 is a perspective view of a rotating shaft and a biasing member;

FIG. 6 is a cross-sectional view along VI-VI in FIG. 1;

FIG. 7 is a cross-sectional view along VII-VII in FIG. 6;

FIG. 8 is a cross-sectional view along VIII-VIII in FIG. 6;

FIG. 9 is a perspective view depicting a modified example of a housing;

FIG. 10 is a cross-sectional view of a flow path switching valve according to a modified example of an embodiment of the present invention; and

FIG. 11 is an enlarged view of a main part in FIG. 10.

### DESCRIPTION OF THE PREFERRED EMBODIMENTS

A flow path switching valve 1 according to an embodiment of the present invention will now be described with reference to the drawings.

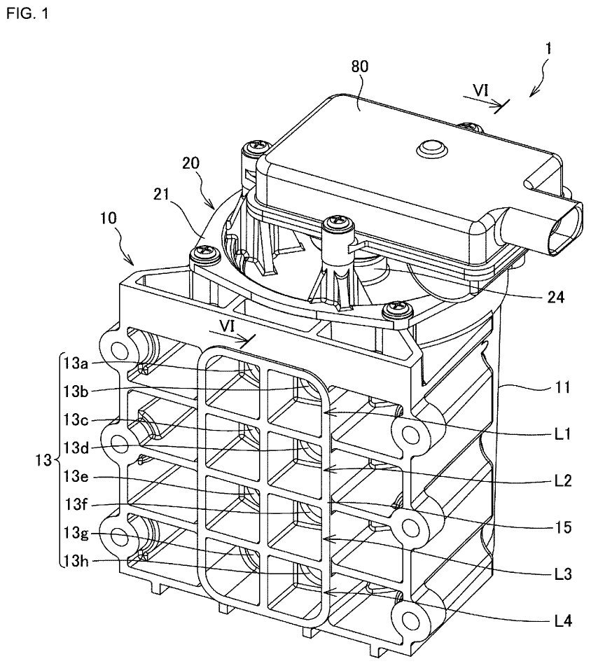

First, the overall configuration of a flow path switching valve 1 will be described with reference to FIG. 1 to FIG. 5.

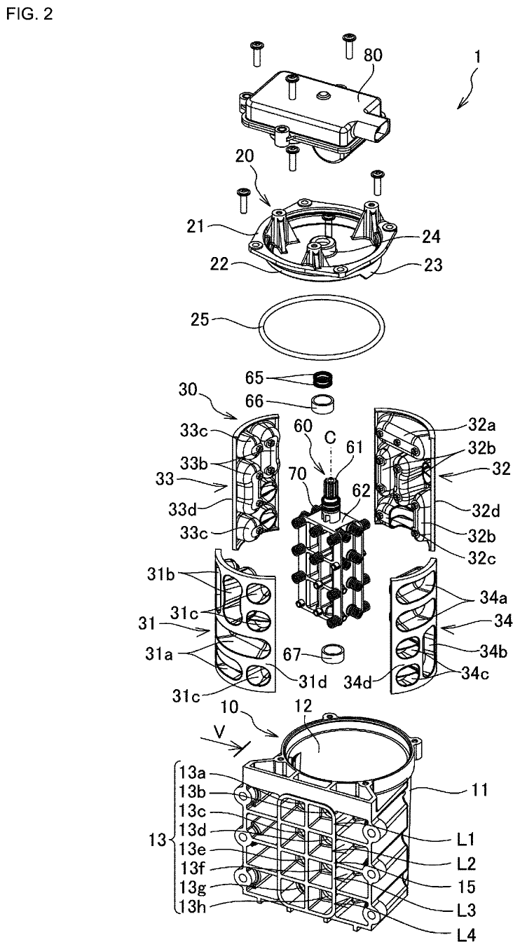

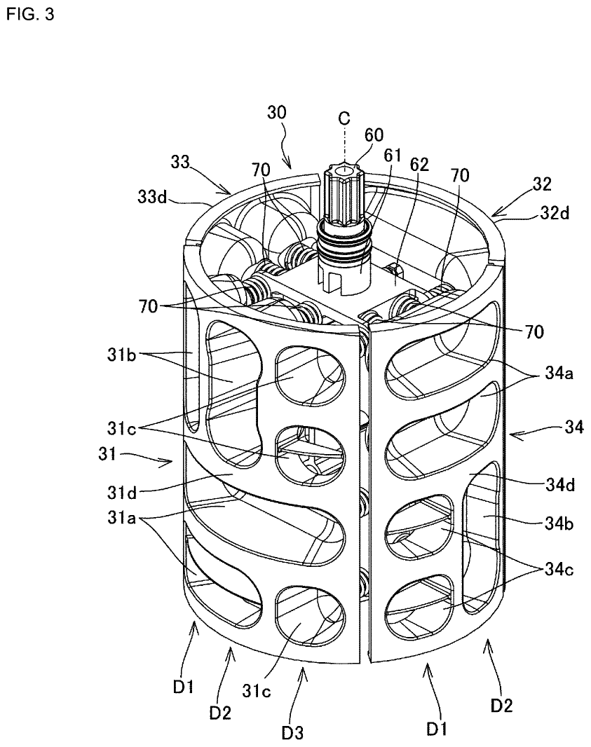

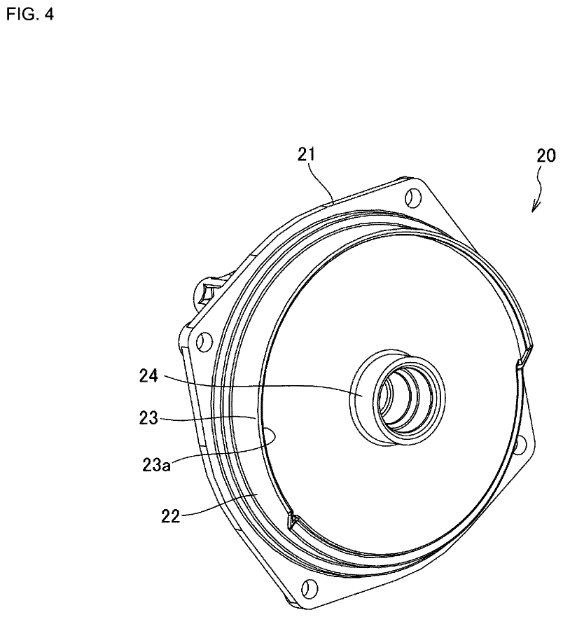

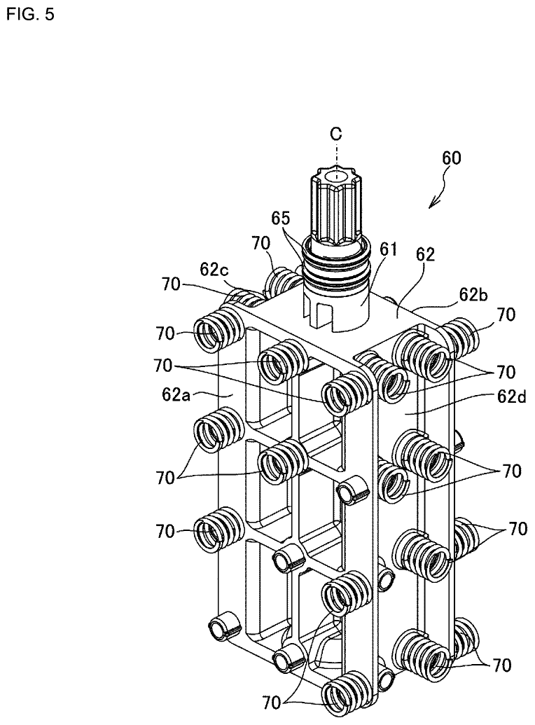

FIG. 1 is an external perspective view of the flow path switching valve 1. FIG. 2 is an exploded perspective view of FIG. 1. FIG. 3 is a perspective view of a valve body 30 and the rotating shaft 60. FIG. 4 is a perspective view of a cover member 20 serving as the cover part. FIG. 5 is a perspective view of the rotating shaft 60 and a plurality of coil springs 70 serving as biasing members.

As depicted in FIG. 1 to FIG. 3, the flow path switching valve 1 includes a housing 10, a valve body 30, a rotating shaft 60, a plurality of coil springs 70, and an actuator 80. The flow path switching valve 1 switches the path through which the cooling water flows as a fluid by rotating the valve body 30 within the housing 10. Note that the fluid flowing through the flow path switching valve 1 may be a liquid other than cooling water.

In the following, the direction along the central axis C of the housing 10 (the central axis of rotation of the valve body 30 and the rotating shaft 60) is referred to as the “axial direction”, the direction from the central axis C of the housing 10 toward the outer diameter is referred to as the “radial direction”, and the direction in which the valve body 30 rotates within the housing 10 is referred to as the “rotational direction” or “circumferential direction”.

As depicted in FIG. 1, the housing 10 has a main body part 11 and a cover member 20. The housing 10 is molded using a mold from a resin material or the like.

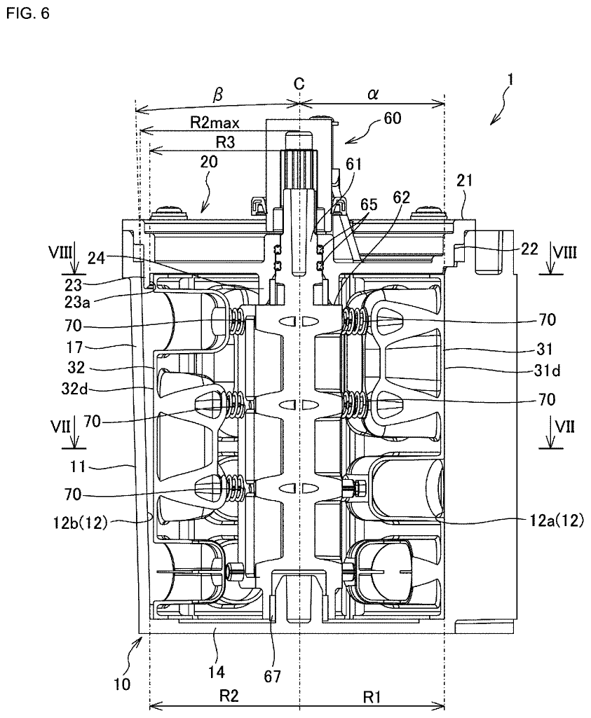

As depicted in FIG. 2, the main body part 11 is formed in a generally cylindrical shape with a bottom. The main body part 11 has an inner wall part 12, a plurality of ports 13, a bottom surface part 14 (see FIG. 6) serving as a bottom part, and a connecting part 15.

The inner wall part 12 is a cylindrical inner circumferential surface of the main body part 11. The inner wall part 12 is formed with a smooth curved surface so that the valve body 30 can slide in contact. A plurality of ports 13 are opened in the inner wall part 12 and are unevenly distributed in a part of the circumferential direction. The inner wall part 12 will be described in detail later with reference to FIG. 6 to FIG. 8.

The ports 13 provide communication between the inner periphery and the outer periphery of the main body part 11. The port 13 is disposed so that the communication state is switched when the valve body 30 rotates about the central axis C by a prescribed angle. The plurality of ports 13 are provided in two rows in the circumferential direction of the housing 10. The ports 13 include a first port 13a, a second port 13b, a third port 13c, a fourth port 13d, a fifth port 13e, a sixth port 13f, a seventh port 13g, and an eighth port 13h.

The first port 13a and the second port 13b are arranged in a row in the circumferential direction to form a first layer L1 as a first stage. The third port 13c and the fourth port 13d are arranged in a row in the circumferential direction to form a second layer L2 as a second stage. The fifth port 13e and the sixth port 13f are arranged in a row in the circumferential direction to form a third layer L3 as a third stage. The seventh port 13g and the eighth port 13h are arranged in a row in the circumferential direction to form a fourth layer L4 as a fourth stage. In other words, the plurality of ports 13 are arranged in four stages in the axial direction: a first layer L1, a second layer L2, a third layer L3, and a fourth layer L4. In addition, a fifth layer (not depicted), a sixth layer (not depicted), and the like may be further provided side by side.

The first port 13a, the third port 13c, the fifth port 13e, and the seventh port 13g are arranged in a row in the axial direction. The second port 13b, the fourth port 13d, the sixth port 13f, and the eighth port 13h are arranged in a row in the axial direction. In other words, the plurality of ports 13 are arranged in a matrix of 4 rows and 2 columns.

The bottom surface part 14 covers a first end in the axial direction (here, the bottom part) of the main body part 11. The bottom surface part 14 rotatably supports the end part of a shaft part 61 of the rotating shaft 60 via a cylindrical collar 67. The bottom surface part 14 is provided integrally with the main body part 11, but may be attached to the main body part 11 as a separate member from the main body part 11.

The connecting part 15 connects each port 13 to an external pipe. The connecting part 15 is provided so as to divide the flow path of the cooling water into a 2×4 grid. The end face of the connecting part 15 is formed into a flat surface. A connecting box (not depicted) in which external piping is collected is connected to the connecting part 15 via a 2×4 grid-shaped seal member (not depicted).

As depicted in FIG. 1 and FIG. 2, the cover member 20 closes the opening part of the main body part 11. As depicted in FIG. 4, the cover member 20 includes an end plate part 21, a cylindrical part 22, an arc part 23, and a shaft support part 24.

The end plate part 21 is formed in a flat plate shape and covers a second end part in the axial direction of the main body part 11. The end plate part 21 closes the second end part of the main body part 11 and, together with the inner wall part 12 and the bottom surface part 14, defines a space in which the valve body 30 is stowed.

The cylindrical part 22 is formed in a cylindrical shape with the first end secured to the end plate part 21. A circular seal member 25 (see FIG. 1) is provided on the outer periphery of the cylindrical part 22 as a sealing member. The cylindrical part 22 seals the inside and outside of the housing 10 by sandwiching and securing the seal member 25 between the cylindrical part 22 and the main body part 11. The cylindrical part 22 has an arc part 23 that is formed in an arc shape along the inner wall part 12 and protrudes toward the inside of the main body part 11.

The arc part 23 protrudes in a part of the axial direction of the main body part 11. The arc part 23 is in sliding contact with parts of seal surfaces 31d, 32d, 33d, and 34d of the valve body 30, which will be described below. The arc part 23 will be described in detail below with reference to from FIG. 6 to FIG. 8.

The shaft support part 24 extends in the axial direction from the inner surface, where the cylindrical part 22 is formed, to the outer surface of the end plate part 21. The shaft support part 24 is formed in a substantially cylindrical shape. The shaft part 61 of the rotating shaft 60 is inserted into the shaft support part 24. The shaft support part 24 rotatably supports the shaft part 61 via a cylindrical collar 66 (see FIG. 2).

As depicted in FIG. 2 and FIG. 3, the valve body 30 is stowed inside the housing 10 so as to be rotatable around a central axis C. The valve body 30 switches the connection state of the plurality of ports 13. The valve body 30 has a first valve body 31, a second valve body 32, a third valve body 33, and a fourth valve body 34. The first valve body 31, the second valve body 32, the third valve body 33, and the fourth valve body 34 are movable radially relative to the central axis C of the housing 10, and are biased toward the inner wall part 12, which is the inner surface of the housing 10, by the coil springs 70. The first valve body 31, the second valve body 32, the third valve body 33, and the fourth valve body 34 are rotatable such that their stopping positions in the rotational direction are different from one another.

The first valve body 31 is formed in a substantially arc shape with a central angle of approximately 110°. The first valve body 31 is provided across the first layer L1 to the fourth layer L4. The first valve body 31 has at least one first communication part 31a that connects the plurality of ports 13 in the axial direction across two or more layers L1 to L4, one second communication part 31b that connects the plurality of ports 13 in the circumferential direction, and one blocking part 31c that blocks the port 13 from connecting with other ports 13.

The first valve body 31 is softer than the main body part 11 of the housing 10, and also softer than the rotating shaft 60. The first valve body 31 has a seal surface 31d that is in sliding contact with the inner wall part 12. The sealing surface 31d is pressed against the inner wall part 12 by the biasing force of the coil springs 70 forming a seal between the sealing surface and the inner wall part 12.

The second valve body 32 is provided at a position facing the first valve body 31 centered on the rotating shaft 60 (central axis C). The second valve body 32 is formed in a substantially arc shape with a central angle of approximately 110°. The second valve body 32 is provided across the first layer L1 to the fourth layer L4. The second valve body 32 has at least one first communication part 32a that connects the plurality of ports 13 in the axial direction across two or more layers L1 to L4, one second communication part 32b that connects the plurality of ports 13 in the circumferential direction, and one blocking part 32c that blocks a port 13 from connecting with other ports 13.

The second valve body 32 is softer than the main body part 11 of the housing 10, and also softer than the rotating shaft 60. The second valve body 32 has a seal surface 32d that is in sliding contact with the inner wall part 12. The sealing surface 32d is pressed against the inner wall part 12 by the biasing force of the coil springs 70 forming a seal between the sealing surface and the inner wall part 12.

The circumferential size of the first valve body 31 and the second valve body 32 is formed to be large enough to allow three ports 13 to be arranged in the circumferential direction. Specifically, the first valve body 31 and the second valve body 32 have a first row D1, a second row D2, and a third row D3. The first valve body 31 and the second valve body 32 can switch their communication states between a first communication state in which the first row D1 and the second row D2 are connected to the port 13, and a second communication state in which the second row D2 and the third row D3 are connected to the port 13. As a result, two communication states can be switched with a single valve body 30, so the number of valve bodies 30 can be reduced relative to the number of communication states that can be switched.

The third valve body 33 is provided between the first valve body 31 and the second valve body 32 in the circumferential direction. The third valve body 33 is formed in a substantially arc shape with a central angle of approximately 70°. The third valve body 33 is provided across the first layer L1 to the fourth layer L4. The third valve body 33 has at least one second communication part 33b that communicates between the plurality of ports 13 in the circumferential direction, and at least one blocking part 33c that blocks the port 13 so as to not communicate with other ports 13. The third valve body 33 may further be provided with a first communication part (not depicted) that connects the plurality of ports 13 in the axial direction across two or more layers L1 to L4.

The third valve body 33 is softer than the main body part 11 of the housing 10, and also softer than the rotating shaft 60. The third valve body 33 has a seal surface 33d that is in sliding contact with the inner wall part 12. A sealing surface 33d is pressed against the inner wall part 12 by the biasing force of the coil springs 70 forming a seal between the sealing surface and the inner wall part 12.

The fourth valve body 34 is provided between the second valve body 32 and the first valve body 31 in the circumferential direction. The fourth valve body 34 is provided at a position facing the third valve body 33 centered on the rotating shaft 60 (central axis C). The fourth valve body 34 is formed in a substantially arc shape with a central angle of approximately 70°. The fourth valve body 34 is provided across the first layer L1 to the fourth layer L4. The fourth valve body 34 has at least one first communication part 34a that connects the plurality of ports 13 in the axial direction across two or more layers L1 to L4, one second communication part 34b that connects the plurality of ports 13 in the circumferential direction, and one blocking part 34c that blocks the port 13 from connecting with other ports 13.

The fourth valve body 34 is softer than the main body part 11 of the housing 10, and also softer than the rotating shaft 60. The fourth valve body 34 has a seal surface 34d that is in sliding contact with the inner wall part 12. A sealing surface 34d is pressed against the inner wall part 12 by the biasing force of the coil springs 70 forming a seal between the sealing surface and the inner wall part 12.

The circumferential size of the third valve body 33 and the fourth valve body 34 is formed to be large enough to allow two ports 13 to be arranged in the circumferential direction. Specifically, the third valve body 33 and the fourth valve body 34 have a first row D1 and a second row D2. The third valve body 33 and the fourth valve body 34 can be switched to a communication state in which the first row D1 and the second row D2 communicate with the port 13.

The direction in which the first valve body 31 faces the second valve body 32 is perpendicular to the direction in which the third valve body 33 faces the fourth valve body 34. In other words, the first valve body 31, the third valve body 33, the second valve body 32, and the fourth valve body 34 are provided in order with a phase difference of 90° in the rotational direction.

As depicted in FIG. 2 and FIG. 3, the rotating shaft 60 extends in the axial direction of the housing 10. The rotating shaft 60 connects the first valve body 31 and the second valve body 32 so as to be movable in opposing directions, and connects the third valve body 33 and the fourth valve body 34 so as to be movable in opposing directions. The rotation of the rotating shaft 60 switches the rotational positions of the first valve body 31, the second valve body 32, the third valve body 33, and the fourth valve body 34.

As depicted in FIG. 5, the rotating shaft 60 has a shaft part 61 formed in a substantially cylindrical shape, and a valve body support part 62 formed in a substantially rectangular parallelepiped shape.

The shaft part 61 is rotatably supported by the cover member 20 via a cylindrical collar 66 (see FIG. 2). A pair of sealing members 65 are provided around the shaft part 61. The gap between the shaft part 61 and the cover member 20 is sealed by a sealing member 65.

The end part of the valve body support part 62 facing the cover member 20 is provided continuous with the shaft part 61 in the axial direction. The valve body support part 62 is formed integrally with the shaft part 61. An end part of the valve body support part 62 facing the bottom surface part 14 is rotatably supported on the bottom surface part 14 of the housing 10 via a cylindrical collar 67 (see FIG. 2). The valve body support part 62 has a first flat surface part 62a, a second flat surface part 62b, a third flat surface part 62c, and a fourth flat surface part 62d.

The first flat surface part 62a is provided opposite the first valve body 31 and supports the first valve body 31 via a plurality of coil springs 70.

The second flat surface part 62b is provided at a position opposite to the first flat surface part 62a across the central axis C. The second flat surface part 62b is provided opposite the second valve body 32 and supports the second valve body 32 via a plurality of coil springs 70.

The third flat surface part 62c is provided between the first flat surface part 62a and the second flat surface part 62b. The third flat surface part 62c is provided opposite the third valve body 33 and supports the third valve body 33 via a plurality of coil springs 70.

The fourth flat surface part 62d is provided between the second flat surface part 62b and the first flat surface part 62a. The fourth flat surface part 62d is provided opposite the fourth valve body 34 and supports the fourth valve body 34 via a plurality of coil springs 70.

The first flat surface part 62a and the second flat surface part 62b are formed to be wider in the circumferential direction of the inner wall part 12 than the third flat surface part 62c and the fourth flat surface part 62d. In other words, the first flat surface part 62a, the second flat surface part 62b, the third flat surface part 62c, and the fourth flat surface part 62d are each formed to a width corresponding to the circumferential size of the valve body 30 that they support. A plurality of coil springs 70 are arranged in three rows on the first flat surface part 62a and the second flat surface part 62b. A plurality of coil springs 70 are arranged in two rows on the third flat surface part 62c and the fourth flat surface part 62d.

As depicted in FIG. 2, a plurality of coil springs 70 are arranged between the first valve body 31 and the rotating shaft 60, between the second valve body 32 and the rotating shaft 60, between the third valve body 33 and the rotating shaft 60, and between the fourth valve body 34 and the rotating shaft 60. The coil springs 70 bias the first valve body 31, the second valve body 32, the third valve body 33, and the fourth valve body 34 towards the inner wall part 12 in which the ports 13 are formed. The coil springs 70 are disposed at a plurality of positions in the axial direction.

The actuator 80 operates upon receiving a command signal from a controller (not depicted). The actuator 80 is connected to the rotating shaft 60 and drives the rotating shaft 60 to rotate. This enables the actuator 80 to set the positions in the rotational direction of the first valve body 31, the second valve body 32, the third valve body 33, and the fourth valve body 34.

The flow path switching valve 1 is preferably disposed so that the position where the port 13 communicates is positioned at the upper part of the housing 10. This enables air mixed in with the cooling water flowing inside the flow path switching valve 1 to be guided to the outside of the flow path switching valve 1 via the port 13. In addition, the flow path switching valve 1 may be disposed so that the cover member 20 is positioned at the upper part of the housing 10. In this case as well, air mixed in the cooling water flowing inside the flow path switching valve 1 can be guided to the outside of the flow path switching valve 1 via the first port 13a and the second port 13b.

Next, the detailed configuration of the housing 10 will be described with reference to from FIG. 6 to FIG. 8.

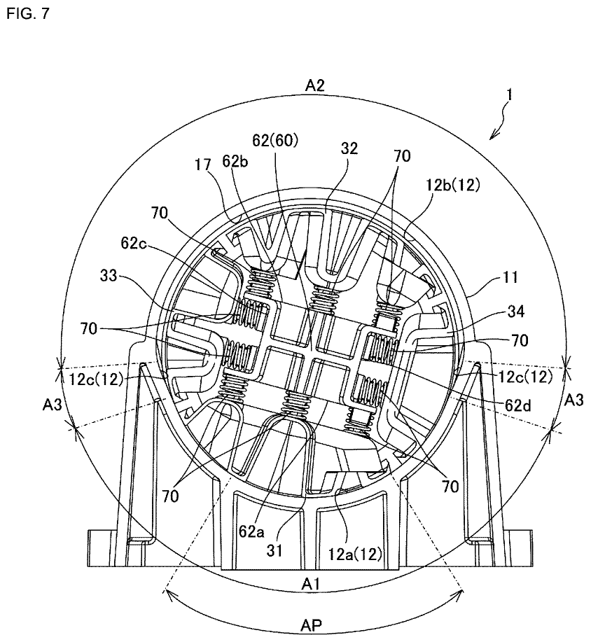

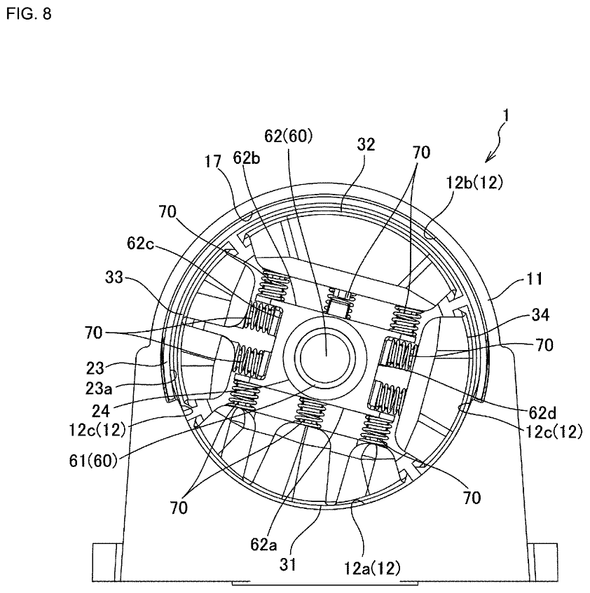

FIG. 6 is a cross-sectional view along line VI-VI in FIG. 1. FIG. 7 is a cross-sectional view along line VII-VII in FIG. 6. FIG. 8 is a cross-sectional view along line VIII-VIII in FIG. 6.

As depicted in FIG. 6 and FIG. 7, the inner wall part 12 has a first inner wall part 12a, a second inner wall part 12b, and a pair of transition parts 12c. The inner wall part 12 is composed of a first inner surface region A1 in which a first inner wall part 12a is provided, a second inner surface region A2 in which a second inner wall part 12b is provided, and a transition region A3 in which a transition part 12c is provided.

The first inner wall part 12a is a curved surface provided on a part of the inner wall part 12 in the circumferential direction. A plurality of ports 13 are provided in the first inner wall part 12a. The first inner wall part 12a is provided parallel to the central axis C. In other words, the inclination angle of the first inner wall part 12a with respect to the central axis C is 0°. The first inner wall part 12a is provided in the first inner surface region A1 of the inner wall part 12. The radius of the first inner surface region A1 from the central axis C is a first radius R1.

The first inner surface region A1 in which the first inner wall part 12a is provided has at least two ports 13 arranged in the circumferential direction, and has a circumferential length that is at least twice the circumferential range AP in which the two ports 13 are arranged. Specifically, the central angle of the circumferential range AP in which the two ports 13 are provided is approximately 60°, whereas the central angle of the first inner surface region A1 is approximately 150°. In addition, the central angle of the first inner surface region A1 is set to be 4/3 times or more the central angle (110°) of the first valve body 31 and the second valve body 32.

Here, the size in the circumferential direction of the first valve body 31 and the second valve body 32 is formed to be large enough to arrange three ports 13 in the circumferential direction. When the first row D1 and the second row D2 of the first valve body 31 and the second valve body 32 are connected to the port 13 (first communication state), the entire first row D1 to the third row D3 abut against the first inner wall part 12a. In addition, when the second row D2 and the third row D3 of the first valve body 31 and the second valve body 32 are connected to the port 13 (second communication state), the entire first row D1 to the third row D3 abut against the first inner wall part 12a.

As a result, regardless of whether the first valve body 31 and the second valve body 32 are switched to the first communication state or the second communication state, the entirety of the sealing surfaces 31d and 32d of the first valve body 31 and the second valve body 32 abut against the first inner wall part 12a. Therefore, it is possible to prevent the first valve body 31 and the second valve body 32 from tilting and changing the abutment state.

The second inner wall part 12b is provided in the second inner surface region A2 of the inner wall part 12. The second inner wall part 12b faces the first inner wall part 12a with the central axis C interposed therebetween. No port 13 is provided in the second inner wall part 12b.

As depicted in FIG. 6, the radius of the second inner wall part 12b (second inner surface region A2) from the central axis C is a second radius R2 that is larger than the first radius R1 (R1<R2). Specifically, the radius of the second inner wall part 12b at the position connected to the bottom surface part 14 is the smallest, and the radius of this position is the second radius R2. In other words, the second inner wall part 12b has an overall radius larger than the first radius R1 of the first inner wall part 12a.

As depicted in FIG. 7, the range in which the second inner surface region A2 is provided is 180° or more when viewed in the axial direction. In other words, the range in which the second inner wall part 12b is provided is 180° or more when viewed in the axial direction. In this manner, by setting the range of the second inner surface region A2 in which the second inner wall part 12b is provided to 180° or more when viewed in the axial direction, the range in which the first inner wall part 12a, which has a smaller radius, is provided is reduced, making it easier to remove the mold when molding using a resin material, or the like.

As depicted in FIG. 6, a radius R2 from the central axis C of the second inner wall part 12b increases from the bottom surface part 14 toward the cover member 20. Specifically, the second radius R2 at the connecting part of the second inner wall part 12b with the bottom surface part 14 is smaller than the maximum second radius R2 max at the opening part of the second inner wall part 12b to which the cover member 20 is attached (R2<R2 max).

The seal surfaces 31d, 32d, 33d, and 34d of the valve body 30 located in the second inner surface region A2 contact the arc part 23 and do not contact the inner wall part 12 over at least a part of the axial direction. Specifically, in the second inner surface region A2, the sealing surfaces 31d, 32d, 33d, and 34d of the valve body 30 contact the inner wall part 12 only near the connecting part with the bottom surface part 14 at the second inner wall part 12b, and do not contact the inner wall part 12 at an axial position closer to the cover member 20.

As a result, the sealing surfaces 31d, 32d, 33d, and 34d of the valve body 30 contact the arc part 23 and do not contact the inner wall part 12 in at least part of the axial direction, thereby reducing the contact area between the sealing surfaces 31d, 32d, 33d, and 34d and the inner wall part 12 and reducing the sliding resistance.

The housing 10 is made of a resin material or the like. Therefore, it is necessary to provide the inner wall part 12 with a draft angle for removing the mold in the axial direction. Therefore, an enlarged diameter part 17 is provided on the housing 10.

The enlarged diameter part 17 is provided on the second inner wall part 12b. The enlarged diameter part 17 has a portion with a radius from the central axis C that is larger than the radius of the first inner wall part 12a, and the radius from the central axis C changes in the axial direction. Specifically, the enlarged diameter part 17 is formed by changing the radius from the central axis C in the axial direction from the second radius R2 to a maximum second radius R2 max.

Alternatively, for example, the radius between the connecting part of the second inner wall part 12b with the bottom surface part 14 and the opening part where the cover member 20 is provided may be the maximum second radius R2 max, and the radius of the approximate center portion in the axial direction between both end parts may be the second radius R2.

In this manner, the second inner wall part 12b is provided with the enlarged diameter part 17. By providing the enlarged diameter part 17, the sliding resistance between the second inner wall part 12b and the valve body 30 is reduced. In addition, the sealing surfaces 31d, 32d, 33d, and 34d of the valve body 30 are in sliding contact with the first inner wall part 12a, so that the communication states of the plurality of ports 13 can be switched while ensuring sealing performance. Therefore, it is possible to ensure sealing performance while reducing sliding resistance.

The relative angle between the inner wall part 12 and the central axis C is a prescribed angle α° including 0° at the first inner wall part 12a, whereas at the second inner wall part 12 b, the angle is a larger angle 3° that is greater than the prescribed angle α° (α<3).

As a result, when the housing 10 is molded using a resin material or the like, the draft angle for removing the mold can be utilized to make the inclination angle of the second inner wall part 12b greater than that of the first inner wall part 12a, thereby forming the enlarged diameter part 17. Furthermore, by providing the enlarged diameter part 17, the sliding resistance between the second inner wall part 12b and the valve body 30 is reduced.

Note that in the housing 10, since the inclination angle a of the first inner wall part 12 a is set to 0° (no draft angle provided), the inclination angle β° of the second inner wall part 12b is set larger than for the case of a draft angle also being provided for the first inner wall part 12a.

The cover member 20 has an arc part 23 that is formed in an arc shape along the inner wall part 12, protrudes toward the inside of the main body part 11, and comes into sliding contact with parts of the seal surfaces 31d, 32d, 33d, and 34d.

By providing the arc part 23 on the cover member 20, the arc part 23 comes into sliding contact with parts of the sealing surfaces 31d, 32d, 33d, and 34d, thereby reducing the contact area between the sealing surfaces 31d, 32d, 33d, and 34d and the arc part 23, and reducing the sliding resistance.

The arc part 23 is positioned on the inner circumference of the second inner wall part 12b in the second inner surface region A2. The arc part 23 is formed in a range such that the central angle is 180° or more. Chamfered parts are formed on the inner peripheral sides of both circumferential ends of the arc part 23. This prevents a step from being formed when the valve body 30 moves from the transition region A3 to the second inner surface region A2, making it possible to make the valve body 30 slide smoothly.

A third radius R3 from the central axis C of a sliding surface 23a in sliding contact with the seal surfaces 31d, 32d, 33d, and 34d at the arc part 23 is greater than a first radius R1 from the central axis C at the first inner wall part 12a.

As a result, the radius R3 of the sliding surface 23a of the arc part 23 is larger than the radius R1 of the first inner wall part 12a, so that when the valve body 30 slides against the arc part 23, the coil spring 70 is in an extended state. Therefore, the contact area between the seal surfaces 31d, 32d, 33d, and 34d and the arc part 23 is reduced, and the pressing force of the seal surfaces 31d, 32d, 33d, and 34d is reduced, so that the sliding resistance can be further reduced.

Note that the third radius R3 of the sliding surface 23a is the same as the second radius R2 at the connecting part between the second inner wall part 12b and the bottom surface part 14 (R3=R2). Therefore, when the valve body 30 is positioned in the second inner surface region A2, the seal surfaces 31d, 32d, 33d, and 34d slide near the connecting part with the bottom surface part 14 of the second inner wall part 12b and against the sliding surface 23a of the arc part 23. Therefore, both axial ends of the valve body 30 come into sliding contact with portions of the same radius, preventing the valve body 30 from tilting and changing position.

The transition part 12c is provided in the transition region A3 of the inner wall part 12. The transition part 12c is a surface that connects the first inner wall part 12a and the second inner wall part 12b. A pair of transition parts 12c are provided to connect both end parts of the first inner wall part 12a and the second inner wall part 12b. The transition part 12c is formed in a substantially planar shape, but the transition part 12c may be formed in a curved surface shape.

The transition region A3 is provided between the first inner surface region A1 and the second inner surface region A2. A pair of transition regions A3 are provided between both end parts of each of the first inner surface region A1 and the second inner surface region A2. The distance of the transition region A3 from the central axis C is greater than the first radius R1 and smaller than the second radius R2. The distance of the transition region A3 from the central axis C is the same as the first radius R1 at the position where the transition region is connected to the first inner surface region A1, and gradually increases to be the same as the second radius R2 at the position where the transition region is connected to the second inner surface region A2.

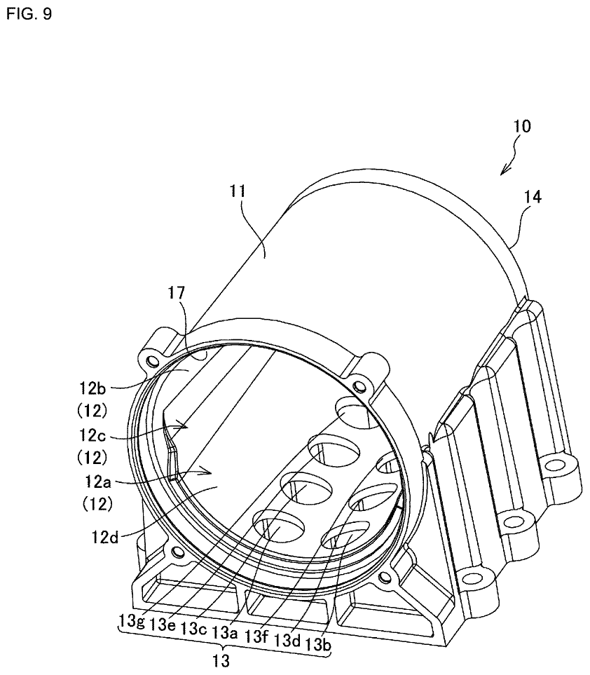

Next, a modified example of the housing 10 will be described with reference to FIG. 9.

FIG. 9 is a perspective view describing a modified example of the housing 10.

In this modified example, the first inner wall part 12a (first inner surface region A1) and the transition part 12c (transition region A3) have a sliding member 12d as a low friction resistance part.

The sliding member 12d has a smaller friction coefficient than the second inner wall part 12b of the second inner surface region A2. The sliding member 12d is formed, for example, from a resin material having a smaller friction coefficient than the material from which the main body part 11 is formed. The sliding member 12d is attached to the main body part 11 as a separate member from the main body part 11. Alternatively, the sliding member 12d may be provided integrally with the main body part 11.

In this manner, by providing the sliding member 12d having a smaller friction coefficient than the second inner wall part 12b, the sliding resistance between the valve body 30 and the sealing surfaces 31d, 32d, 33d, and 34d can be reduced compared to when the sliding member 12d is not provided.

Note that in a state where the sliding member 12d is provided, the radius of the inner circumferential surface of the sliding member 12d from the central axis C is the first radius R1. Therefore, the position in the radial direction of the valve body 30 is not changed in the first inner surface region A1.

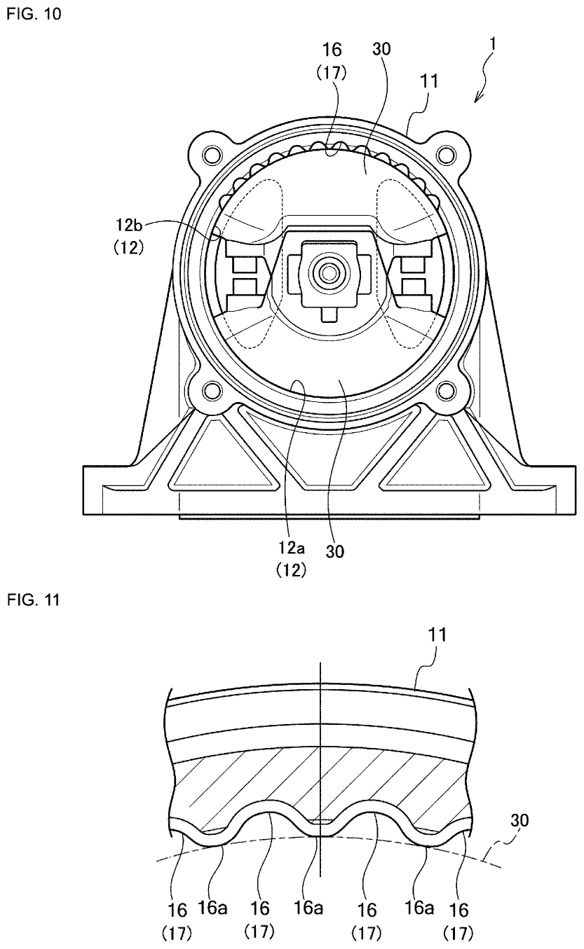

Next, a modified example of the present embodiment will be described with reference to FIG. 10 and FIG. 11.

FIG. 10 is a cross-sectional view of a flow path switching valve 1 according to a modified example of the embodiment of the present invention. FIG. 11 is an enlarged view of a main part in FIG. 9.

In the modified example depicted in FIG. 10 and FIG. 11, the housing 10 has a plurality of slits 16 as the enlarged diameter part 17.

As depicted in FIG. 10, a slit 16 is provided in the inner wall part 12 of the housing 10 and extends in the axial direction. The slit 16 is provided in the second inner wall part 12b. The slit 16 corresponds to an enlarged diameter part 17 having a portion with a larger radius from the central axis C than the first inner wall part 12a and whose radius from the central axis C changes in the radial direction. In this case, the enlarged diameter part 17 is formed by changing the radius from the central axis C in the radial direction.

The slit 16 reduces the contact area between the inner wall part 12 where the port 13 is formed and the seal part of the valve body 30 described later at another position of the inner wall part 12 opposite the central axis C, thereby reducing sliding resistance. Thereby, the drive torque of the actuator 80 can be reduced, enabling use of a small actuator 80. Therefore, the entire flow path switching valve 1 can be made compact.

As depicted in FIG. 11, the slits 16 are formed so that adjacent slits 16 in the circumferential direction are connected by a continuous smooth curved surface. A contact surface 16a is formed between adjacent slits 16.

The contact surface 16a is a curved surface formed with the same curvature as the inner wall part 12, and constitutes a part of the inner wall part 12. By providing the contact surface 16a, the seal part of the valve body 30 and the contact surface 16a are in surface contact rather than line contact, so as to disperse the force acting on the valve body 30 when the seal part of the valve body 30 is pressed against the inner wall part 12.

The Following Effects Are Achieved by the Aforementioned Embodiment.

The flow path switching valve 1 includes a housing 10 having a cylindrical inner wall part 12 and in which a plurality of ports 13 are unevenly distributed and open in a part in the circumferential direction, and a plurality of valve bodies 30 that are rotatably stowed inside the housing 10 around a central axis C and have seal surfaces 31d, 32d, 33d, and 34d that slide against the inner wall part 12 and switch the communication state of the plurality of ports 13. The inner wall part 12 has a first inner wall part 12a on which the plurality of ports 13 are provided, and a second inner wall part 12b that faces the first inner wall part 12a across the central axis C and on which no ports 13 are provided. The second inner wall part 12b has an enlarged diameter part 17 that has a portion with a larger radius from the central axis C than the first inner wall part 12a and whose radius from the central axis C changes in the axial or radial direction.

In addition, the flow path switching valve 1 further includes a rotating shaft 60 extending in the axial direction and that switches the rotational position of the valve body 30 through rotation thereof, and a plurality of coil springs 70 provided between the rotating shaft 60 and the valve body 30 for biasing the valve body 30 toward the inner wall part 12, and the sealing surfaces 31d, 32d, 33d, and 34d are pressed against the inner wall part 12 by the biasing force of the coil springs 70 to seal therebetween with the inner wall part 12.

According to these configurations, the inner wall part 12 of the housing 10 has a first inner wall part 12a in which a plurality of ports 13 are provided, and a second inner wall part 12b opposite the first inner wall part 12a across the central axis C in which no ports 13 are provided. The second inner wall part 12b has an enlarged diameter part 17 having a portion with a larger radius from the central axis C than the first inner wall part 12a, and the radius from the central axis C changes in the axial or radial direction. Therefore, by the sealing surfaces 31d, 32d, 33d, and 34d of the valve body 30 slidingly contacting the first inner wall part 12a, the communication state of the plurality of ports 13 can be switched while ensuring sealing performance, and by providing the enlarged diameter part 17, the sliding resistance between the valve body 30 and the second inner wall part 12b is reduced. Therefore, it is possible to ensure sealing performance while reducing sliding resistance.

The enlarged diameter part 17 is formed by changing the radius from the central axis C in the axial direction, and the relative angle between the inner wall part 12 and the central axis C is a prescribed angle a including 0° at the first inner wall part 12a, while this relative angle is the angle β, which is larger than the prescribed angle a, at the second inner wall part 12b.

The housing 10 has a main body part 11 having an inner wall part 12 and a plurality of ports 13 opening therein, a bottom surface part 14 covering a first end in the axial direction of the main body part 11, and a cover member 20 covering the second end of the main body part 11 in the axial direction, and a radius R2 from the central axis C of the second inner wall part 12b expands from the bottom surface part 14 toward the cover member 20.

According to these configurations, when the housing 10 is molded using a resin material or the like, the draft angle for removing the mold can be utilized to make the inclination angle of the second inner wall part 12b greater than that of the first inner wall part 12a, thereby forming the enlarged diameter part 17. By providing the enlarged diameter part 17, the sliding resistance between the second inner wall part 12b and the valve body 30 is reduced.

The cover member 20 has an arc part 23 that is formed in an arc shape along the inner wall part 12, protrudes toward the inside of the main body part 11, and comes into sliding contact with parts of the seal surfaces 31d, 32d, 33d, and 34d.

According to this configuration, the arc part 23 provided on the cover member 20 slides against a part of the sealing surfaces 31d, 32d, 33d, and 34d, thereby reducing the contact area between the sealing surfaces 31d, 32d, 33d, and 34d and the arc part 23, thereby reducing the sliding resistance.

A radius R3 from the central axis C of a sliding surface 23a in sliding contact with the seal surfaces 31d, 32d, 33d, and 34d at the arc part 23 is greater than a radius R1 from the central axis C at the first inner wall part 12a.

According to this configuration, the radius R3 of the sliding surface 23a of the arc part 23 is larger than the radius R1 of the first inner wall part 12a, so that when the valve body 30 slides against the arc part 23, the coil spring 70 is in an extended state. Therefore, the contact area between the seal surfaces 31d, 32d, 33d, and 34d and the arc part 23 is reduced, and the pressing force of the seal surfaces 31d, 32d, 33d, and 34d is reduced, so that the sliding resistance can be further reduced.

The seal surfaces 31d, 32d, 33d, and 34d of the valve body 30 located in the second inner surface region A2 contact the arc part 23 and do not contact the inner wall part 12 over at least a part of the axial direction.

According to this configuration, the sealing surfaces 31d, 32d, 33d, and 34d of the valve body 30 contact the arc part 23 and do not contact the inner wall part 12 in at least part of the axial direction, thereby reducing the contact area between the sealing surfaces 31d, 32d, 33d, and 34d and the inner wall part 12 and reducing the sliding resistance.

The range in which the second inner wall part 12b is provided is 180° or more when viewed in the axial direction. In other words, the range in which the second inner surface region A2 is provided is 180° or more when viewed in the axial direction.

According to this configuration, by setting the range of the second inner surface region A2 in which the second inner wall part 12 b is provided to 180° or more when viewed in the axial direction, it is possible to make it easier to remove the mold when molding using a resin material, or the like.

The first inner surface region A1 has at least two ports 13 arranged in the circumferential direction, and has a circumferential length that is at least twice that of the circumferential range AP in which the two ports 13 are provided.

According to this configuration, the size in the circumferential direction of the first valve body 31 and the second valve body 32 is formed to be large enough to arrange three ports 13 in the circumferential direction. Therefore, when the first row D1 and the second row D2 of the first valve body 31 and the second valve body 32 are connected to the port 13, the entire first row D1 to the third row D3 abut against the first inner wall part 12a. In addition, when the second row D2 and the third row D3 of the first valve body 31 and the second valve body 32 are connected to the port 13, the entire first row D1 to the third row D3 abut against the first inner wall part 12a.

As a result, the entire sealing surfaces 31d and 32d of the first valve body 31 and the second valve body 32 abut against the first inner wall part 12a, thereby preventing the first valve body 31 and the second valve body 32 from tilting and changing the abutment state.

The first inner surface region A1 and the transition region A3 have a sliding member 12d having a smaller friction coefficient than the second inner wall part 12b of the second inner surface region A2.

According to this configuration, by providing the sliding member 12d having a smaller friction coefficient than the second inner wall part 12b, the sliding resistance between the valve body 30 and the sealing surfaces 31d, 32d, 33d, and 34d can be reduced compared to when the sliding member 12d is not provided.

The enlarged diameter part 17 is formed by changing the radius from the central axis C in the radial direction. The enlarged diameter part 17 has a plurality of slits 16 extending in the axial direction on the second inner wall part 12b of the housing 10.

According to these configurations, the slit 16 reduces the contact area between the inner wall part 12 where the port 13 is formed and the seal part of the valve body 30 described later at another position of the inner wall part 12 opposite the central axis C, thereby reducing sliding resistance. Thereby, the drive torque of the actuator 80 can be reduced, enabling use of a small actuator 80. Therefore, the entire flow path switching valve 1 can be made compact.

The first inner surface region A1 and the transition region A3 have a sliding member 12d having a smaller friction coefficient than the second inner wall part 12b of the second inner surface region A2.

According to this configuration, by providing the sliding member 12d having a smaller friction coefficient than the second inner wall part 12b, the sliding resistance between the valve body 30 and the sealing surfaces 31d, 32d, 33d, and 34d can be reduced compared to when the sliding member 12d is not provided.

Embodiments of the present invention have been described above, so the above-mentioned embodiments merely depict some of the application examples of the present invention, and are not intended to restrict the technical scope of the present invention to the specific configurations of the above-mentioned embodiments.

This application claims priority based on Japanese Patent Application No. 2023-062269 filed with the Japan Patent Office on Apr. 6, 2023, and Japanese Patent Application No. 2024-051495 filed with the Japan Patent Office on Mar. 27, 2024. The entire contents of these applications are incorporated herein by reference.

1. A flow path switching valve, comprising:
a housing having a cylindrical inner wall part and in which a plurality of ports are unevenly distributed and open in a part of the circumferential direction; and
a plurality of valve bodies that are stowed inside the housing so as to be rotatable about a central axis and have sealing surfaces that come into sliding contact with the inner wall part and switch communication states of the plurality of ports; wherein
the inner wall part includes a first inner wall part in which the plurality of ports are provided, and a second inner wall part that faces the first inner wall part across the central axis and in which ports are not provided, and
the second inner wall part has an enlarged diameter part having a portion with a larger radius from the central axis than the first inner wall part, and the radius from the central axis changes in the axial direction or radial direction.

2. The flow path switching valve according to claim 1, further comprising:
a rotary shaft that extends in the axial direction, the rotation of which switches the rotational position of the valve body; and
a biasing member provided between the rotating shaft and the valve body and configured to bias the valve body toward the inner wall part; wherein
the seal surface is pressed against the inner wall part by the biasing force of the biasing member to form a seal with the inner wall part.

3. The flow path switching valve according to claim 2, wherein the enlarged diameter part is formed by changing the radius from the central axis in the axial direction, and
a relative angle between the inner wall part and the central axis is a prescribed angle including 0° at the first inner wall part, whereas at the second inner wall part, the angle is larger than the prescribed angle.

4. The flow path switching valve according to claim 3, wherein the housing includes:
a main body part having the inner wall part and into which the plurality of ports open;
a bottom part covering a first end of the main body part in the axial direction; and
a cover part for covering the second end of the main body part in the axial direction; and
the radius of the second inner wall part from the central axis increases from the bottom part toward the cover part.

5. The flow path switching valve according to claim 4, wherein
the cover part has an arc part formed in an arc shape along the inner wall part, protruding toward the inside of the main body part and in sliding contact with a part of the seal surface.

6. The flow path switching valve according to claim 5, wherein
the radius from the central axis of a sliding surface that is in sliding contact with the seal surface at the arc part is larger than the radius of the first inner wall part from the central axis.

7. The flow path switching valve according to claim 6, wherein
the inner wall part comprises:
a first inner surface region in which the first inner wall part is provided and for which a radius from the central axis is a first radius;
a second inner surface region in which the second inner wall part is provided and for which a radius from the central axis is a second radius, larger than the first radius; and
a transition region provided between the first inner surface region and the second inner surface region, and having a distance from the central axis that is larger than the first radius and smaller than the second radius.

8. The flow path switching valve according to claim 7, wherein the seal surface of the valve body located in the second inner surface region is in contact with the arc part and is not in contact with the inner wall part for at least a part of the axial direction.

9. The flow path switching valve according to claim 1, wherein the range in which the second inner wall part is provided is 180° or more when viewed in the axial direction.

10. The flow path switching valve according to claim 9, wherein the inner wall part comprises:
a first inner surface region in which the first inner wall part is provided and for which a radius from the central axis is a first radius;
a second inner surface region in which the second inner wall part is provided and for which a radius from the central axis is a second radius, larger than the first radius; and
a transition region provided between the first inner surface region and the second inner surface region, and having a distance from the central axis that is larger than the first radius and smaller than the second radius, wherein
the range in which the second inner surface region is provided is 180°or more when viewed in the axial direction.

11. The flow path switching valve according to claim 10, wherein the first inner surface region has at least two ports arranged in the circumferential direction, and has a circumferential length that is at least twice that of the circumferential range in which the two ports are provided.

12. The flow path switching valve according to claim 11, wherein the first inner surface region and the transition region have a low friction resistance part having a friction coefficient smaller than that of the second inner wall part of the second inner surface region.

13. The flow path switching valve according to claim 1, or wherein the enlarged diameter part is formed by changing the radius from the central axis in the radial direction.

14. The flow path switching valve according to claim 13, wherein the enlarged diameter part has a plurality of slits extending in the axial direction on the second inner wall part of the housing.

15. The flow path switching valve according to claim 14, wherein the inner wall part comprises:
a first inner surface region in which the first inner wall part is provided and for which a radius from the central axis is a first radius;
a second inner surface region in which the second inner wall part is provided and for which a radius from the central axis is a second radius that is greater than the first radius; and
a transition region provided between the first inner surface region and the second inner surface region, and having a distance from the central axis that is larger than the first radius and smaller than the second radius, wherein
the first inner surface region and the transition region have a low friction resistance part having a friction coefficient smaller than that of the second inner wall part of the second inner surface region.
